(19) United States
(12) Patent Application Publication
(10) Pub. No.: US 2010/0274640 A1
(43) Pub. Date: Oct. 28, 2010

(54) MANAGEMENT OF CLEANING PROCESSES VIA MONITORING OF CHEMICAL PRODUCT USAGE

(75) Inventors: John D. Morey, St. Paul, MN (US); Bryan M. Anderson, St. Paul, MN (US); Eric R. Balz, Stillwater, MN (US); Timothy R. Snellen, Marlton, NJ (US)

Correspondence Address: SHUMAKER & SIEFFERT, P. A., 1625 RADIO DRIVE, SUITE 300, WOODBURY, MN, 55125, US

(73) Assignee: Ecolab USA Inc., St. Paul, MN (US)

(21) Appl. No.: 12/766,714

(22) Filed: Apr. 23, 2010

Related U.S. Application Data
(60) Provisional application No. 61/172,508, filed on Apr. 24, 2009.

(51) Int. Cl. G06Q 10/00; G06F 15/16; G06Q 50/00; G06F 17/00

(52) U.S. Cl. 705/11; 709/224; 705/7; 700/244

(57) ABSTRACT

A cleaning process management system monitors information concerning chemical products dispensed by automated chemical product dispensers. The cleaning process management system analyzes data received from the dispensers and generates reports regarding dispensation of chemical products. The cleaning process management system may also generate reports concerning recommended cleaning process improvements based on the analysis of the dispenser data.

### CROSS REFERENCE TO RELATED APPLICATIONS

This application claims the benefit of U.S. provisional Application Ser. No. 61/172,508 filed Apr. 24, 2009, the entire contents of which is incorporated herein by reference.

### TECHNICAL FIELD

The invention relates generally to dispensation of chemical products.

### BACKGROUND

Various institutional industries, such as food service, hotels, hospitality, healthcare, office buildings, schools, retail establishments, etc., employ or contract with cleaning services to maintain the cleanliness of their facilities. Such facilities often employ automated or semi-automated chemical product dispensers to dispense chemical cleaning products, such as air freshener, bathroom cleaner, glass cleaner, all purpose cleaner, disinfectants, sanitizers, etc. The chemical product dispensers allow cleaning personnel to dispense the products necessary to perform the cleaning functions and may also control and/or manage the amount or volume of chemical product dispensed or the timing of the dispensation.

In a cleaning operation, target volumes or weights of chemical product may be required to achieve the best result. For some applications, if too little or too much product is used, a less than optimal cleaning result may occur. For example, if an employee does not dispense sufficient cleaning product for a specific application, the area may not be adequately cleaned and/or disinfected.

Unfortunately, operator error can result in use or dispensation of less than optimal amounts of cleaning products (or even, in some cases, no cleaning product). Such errors, which may be exacerbated by improper cleaning procedures, can lead in improper cleaning, which may further result in the incomplete removal of visible soil and/or potentially dangerous pathogens. Other costly inefficiencies can include the dispensing of too much product and thus increasing costs without any concomitant benefit.

In addition, individual institutional cleaning accounts tend to be geographically dispersed, requiring many individual field service managers to physically visit individual cleaning accounts periodically, to monitor product usage on a periodic basis at those operations, and to provide corrective instructions to the corresponding cleaning employees.

### SUMMARY

In general, the invention relates to a comprehensive and systematic approach to cleaning and sanitizing practices based on monitoring of chemical product dispensation.

In one example, the invention is direct to a system comprising a server computer that receives dispenser data from a chemical product dispenser located at a cleaning site, the dispenser data including an amount of a chemical product dispensed by the chemical product dispenser, a database coupled to the server computer that stores the dispenser data in association with corporate data regarding the cleaning site and that stores cleanliness metrics associated with the dispensing site; wherein the corporate data includes cleaning site identification information, corporate target amounts of chemical product to be dispensed, and at least one target cleanliness metric, an analysis application resident on the server computer that analyzes the dispenser data in combination with at least some of the corporate data and generates therefrom product usage data indicative of the actual amount of chemical product usage at the cleaning site, and analyzes the cleanliness metrics in combination with the target cleanliness metrics, and a reporting application resident on the server computer that generates reports based on the analysis.

In another embodiment, the invention is directed to a system comprising a memory that stores dispenser data obtained by one or more chemical product dispensers located at a cleaning site, the dispenser data including actual amounts of chemical products dispensed by the one or more chemical product dispensers, wherein the memory further stores corporate data including cleaning site identification information, corporate target amounts of chemical products to be dispensed, and at least one target cleanliness metric, wherein the memory further stores cleanliness metrics associated with the dispensing site, and a processing apparatus that analyzes the dispenser data the cleanliness metrics and generates reports based on the analysis.

In another embodiment, the invention is directed to a system comprising one or more cleaning sites, each cleaning site including one or more chemical product dispensers that dispense at least one chemical product and generate dispenser data indicative of actual amounts of chemical product dispensed, and a server computer in communication with each of the cleaning sites, the server computer including an analysis application that analyzes the dispenser data and the cleanliness metrics associated with each cleaning site, and a reporting application that generates reports based on the analysis.

In other examples, the invention may be directed to methods performed by the cleaning process management system or computer readable media comprising instructions that cause a processor to execute the cleaning process management methods described herein.

The details of one or more examples of the invention are set forth in the accompanying drawings and the description below. Other features and advantages of the invention will be apparent from the description and drawings, and from the claims.

### BRIEF DESCRIPTION OF DRAWINGS

FIG. 1 is a block diagram illustrating an example cleaning process management system.

FIG. 2 is a block diagram illustrating an example cleaning site having one or more chemical product dispensers.

FIG. 3 is a block diagram illustrating an example cleaning process management flow maps.

FIGS. 4-13 show example reports that may be generated by reporting module 230.

FIG. 14 is a flowchart illustrating an example process by which the cleaning process management system may manage a cleaning process.

### DETAILED DESCRIPTION

The cleaning process management techniques described herein relate to management of cleaning and sanitizing practices based on monitoring of chemical product dispensation. The cleaning process management techniques may monitor, analyze and generate reports concerning cleaning chemical product usage data independently or in conjunction with cleanliness metrics (cleaning scores). The chemical product usage data may be analyzed to determine whether proper amounts of the chemical cleaning products are being used. In addition, the chemical product usage data may be analyzed in conjunction with the cleanliness metrics to determine a connection between chemical product usage and cleaning scores. The cleaning process management techniques may also generate and present reports concerning the chemical product usage data and/or the results of the analysis. For example, reports may be generated that compare the actual and target chemical product usage and/or cleanliness metrics for a particular cleaning site, across multiple cleaning sites, or across a corporation. The cleaning process management system may also generate reports concerning recommended cleaning process improvements if the targets are not met.

The cleaning process management system monitors information concerning products dispensed by chemical product dispensers. The cleaning process management system may incorporate any of a number of different types of chemical product dispensers, such as fluid product dispensers, solid product dispensers, concentrate product dispensers, pelleted product dispensers, granular product dispensers, etc. The dispensers may dispense chemical products at full strength or may combine the chemical products with a diluent, such as water, to dispense a diluted chemical product use solution having a desired concentration of an active ingredient. The dispensers may also combine one or more chemical products, with or without a diluent, to dispense a blended chemical product use solution. It shall be understood that any type of automated or semi-automated chemical product dispenser may be utilized and that the invention is not limited in this respect. In addition, each cleaning site may include more than one type of chemical product dispenser depending upon the chemical product(s) to be dispensed at that site.

The chemical product dispensers may monitor the amount (e.g., volume or weight) of chemical product dispensed during each dispensing cycle, and store this so-called “chemical usage data”. The chemical product dispensers may also monitor the times at which such products are dispensed and/or the identity of the person associated with each dispensation, etc.

The chemical product dispenser may determine the amount of product dispensed by any methods known to those of skill in the art, including flow meter monitoring of the amount of concentrate product used, flow meter monitoring of the amount of diluents used, flow meter monitoring the amount of use solution dispensed, time the dispenser was actively dispensing, flow sensors to monitor the presence of flow of the concentrate, flow sensors to monitor the presence of flow of the diluent, flow sensor to monitor the presence of flow of the use solution, weight-based monitoring such as weight loss of a chemical product or weight gain of a receiving container, float sensors, optical sensing, etc.

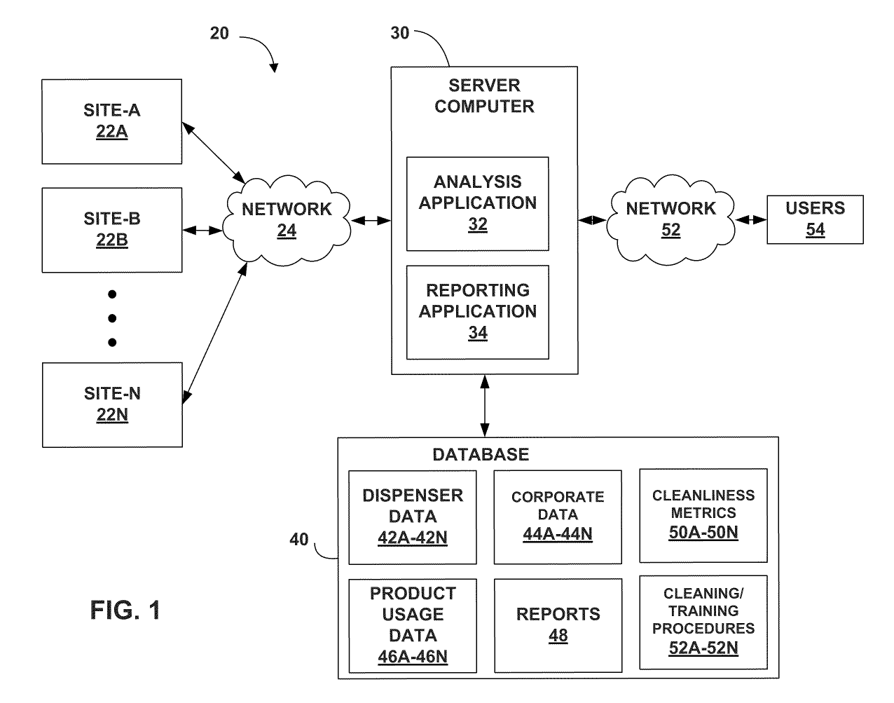

FIG. 1 is a block diagram illustrating an example cleaning process management system 20. In this example, one or more cleaning sites 22A-22N are coupled via a network 24 to a server computer 30. Cleaning sites 22A-22N may be, for example, any type of site or facility at which cleaning services are performed and chemical products are dispensed, such as restaurants or other food service facilities; hospitality facilities including hotels, cruise ships, resorts, amusement parks, casinos, etc.; healthcare facilities such as hospitals, clinics, surgical centers, long term care facilities, assisted living facilities, etc.; office buildings; schools; retail establishments; and the like. Although a multiple-site/server computer system is shown, it shall be understood that the cleaning process management techniques described herein could also be used locally at a single site having one or more dispensers, and the invention is not limited in this respect.

Network 24 may include, for example, a dial-up connection, a local area network (LAN), wide area network (WAN), the internet, etc. The connection may be wired or wireless. Server computer 30 may be coupled to a local server computer at each cleaning site 22A-22N via network 24 to receive chemical product dispensing information from each cleaning site 22A-22N. The server computer 30 or other computer, such as laptop or desktop computer, may also be connected locally to receive information from the dispensers at a site via a hardwired connection such as a cable connector. Alternatively or in addition, a portable computer, tablet PC, cell phone enabled or other type of remote computer may receive the chemical product dispensing information from one or more of the sites 22.

The data received from sites 22A-22N, as well as other data associated with cleaning process management, may be stored on a database 40. Database 40 may store, for example, dispenser data 42A-42N, corporate data 44A-44N and product usage data 46A-46N associated with sites 22A-22N, respectively. Database 40 may also store reports 48 generated for each site 22A-22N, respectively. Reports 48 may include reports specific to each site, reports concerning multiple sites or groupings of sites, etc. Database 40 may also store cleanliness metrics 50A-50N associated with sites 22A-22N, respectively.

Database 40 may be part of server computer 30 or may be separate from server computer 30. Database 40 may also be local to or remotely located from server computer 30. Alternatively or in addition, the information associated with each site stored on database 40 may be stored locally at each site. Each site may also include an analysis 32 and/or reporting application 34 for carrying out analysis and reporting functions locally at the site. Also, rather than a multiple-site/server set up such as shown in FIG. 1, each site could store its own data and perform its own analysis and reporting functions locally. Each of these and other system architectures known in the art are contemplated, and the invention is not limited in this respect.

Information monitored or collected by the dispensers is referred to herein as “dispenser data.” The dispenser data may be stored on each individual dispenser, locally at the site and/or on the server database 40 as dispenser data 42A-42N. Dispenser data refers to data relating to chemical product usage or use of a chemical product dispenser. For example, dispenser data may include data concerning the volume, mass, weight or other unit of measure that quantifies the amount or quantity of chemical product dispensed (hereinafter referred to generally as the amount of chemical product dispensed). Dispenser data may also include other relevant dispenser information, such as information concerning the dispensed chemical product such as product name, product classification (e.g., air freshener, sanitizer, disinfectant, bathroom cleaner, all-purpose cleaner, etc.), the number of times a chemical product is dispensed over a known period of time, dispensing times, dates and sequences, empty product indications, etc. In the case of a dispenser that mixes a chemical product with a diluent, dispenser data may include information regarding the amount of chemical product dispensed, the amount of diluent added, and/or the final concentration of active ingredient in the resulting dispensed product. Dispenser data may also include information concerning the dispenser itself such as dispenser id, date/time of dispensing, employee id, dispenser error information, utility (e.g., electric, gas or water) usage, total dispensing time, total operating time, dispenser performance information, product empty indications, water flow volumes, and other information originating at the dispenser, whether detected by a dispenser or by an associated device (such as a remote temperature probe, concentration monitor, etc.).

“Corporate data” 44A-44N may include any information related to the site or to a corporation associated with one or more sites, such as site identification information, corporate identification information, account information, alignment information (such as site classifications based on type of site, classifications based on type of dispenser, etc.), utility costs, chemical costs, employee shift information, labor costs, and additional information relating to other aspects of the corporation or site operation. Corporate data may also include corporate-wide performance targets, site-specific performance targets customized to a particular site or sites, or dispenser-specific performance targets customized to a particular dispenser at a particular site. These corporate, site-specific or dispenser-specific performance targets may include targets specifying the amount of each chemical product that should be dispensed per unit time, chemical cost targets, utility cost targets, etc. Corporate data 44A-44N may be stored and analyzed alone or in combination with dispenser data 42A-42N. Corporate data may also be stored locally on each dispenser or at each dispenser site.

“Product usage data” 46A-46N is that data generated by analysis application and may include information based on dispenser data alone, corporate data alone, or a combination of dispenser data and corporate data. One example of product usage data 46 could be a comparison between the total dispensed amount of a particular chemical product per unit time and a target dispensed amount for that chemical product per unit time. These comparisons could be given on a per dispenser, per site, per grouping, or per corporate-wide basis. Another example may be a comparison between the total dispensed amount of a particular chemical product per dispense event and a target dispensed amount for each dispense event. These comparisons could be given on a per dispenser, per site, per grouping, or per corporate-wide basis. Other examples of product usage data may include comparisons of other types of dispenser data to relevant corporate, site-specific or dispenser-specific targets, totalized or benchmarked dispenser data. Product usage data may also include labor usage information, utility usage information, chemical costs, utility costs, labor costs, maintenance information, procedural error information and performance information. The product usage data may be generated on a dispenser, site, alignment (grouping) or corporate level. The product usage data may also be generated based on chemical product, type of chemical product, employee, service provider, location, region, etc., or by any other parameter by which the dispenser and corporate data may be analyzed.

The product usage data to be generated may be programmed into the analysis and/or reporting applications and automatically generated or may be selectable by a user.

Cleanliness metrics 50A-50N may include, for example, cleanliness scores concerning each site 22A-22N, respectively. The cleanliness metrics 50A-50N may include those obtained from guests, customers or other users of the site. For example, if the site is a hotel, cleanliness metrics may be obtained from hotel guests via comment cards, online surveys, online forum reviews, verbal communications, etc. As another example, if the site is a restaurant or other food service facility, cleanliness metrics may similarly be obtained from customers via comment cards, online surveys, online forum reviews, verbal communications, etc. The cleanliness metrics may also include cleanliness scores from brand (corporate-level), local cleaning management, or regional cleaning management audits of cleaning effectiveness. The cleanliness metrics may also include results of pathogen swab tests or other tests that measure cleaning/disinfecting effectiveness.

Cleaning/training procedures 52A-52N may include, for example, the details concerning one or more cleaning processes and/or training procedures to be used at the sites 22A-22N. The cleaning/training procedures 52A-52N may be customized to each individual site or may be customized on a regional or corporate-wide level. The cleaning/training procedures 52A-52N may include those procedures to be followed when target parameters (such as chemical product usage targets and/or target cleanliness metrics) are being met. The cleaning/training procedures 52A-52N may also include one or more procedures to be followed when one or more of the target parameters are not being met. The specific cleaning/training procedures recommended at any particular time may be based on the analysis of the dispenser data and/or the cleanliness metrics. For example, if the target parameters have been continually met over a period of time, the system may simply recommend that current cleaning and/or training processes be continued. As another example, if the target parameters have been generally met over a period of time, and the target parameters are not met during the next reporting period, the system may simply recommend that cleaning activities at the site be monitored for future results but not recommend any specific new cleaning procedures or training. As another example, if one or more target parameters are not met over a defined period of time, the system may recommend specific new cleaning procedures and/or training directed at bringing the chemical product usage and/or cleanliness metrics back into target.

Server computer 30 includes an analysis application 32 that analyzes dispenser data 42A-42N received from each of sites 22A-22N either alone or in combination with corporate data 44A-44N and/or cleanliness metrics 50A-50N. Server computer 30 may store at least some of the results in database 40 as product usage data 46A-46N. A reporting application 34 generates a variety of reports 48 that present the product usage data 46A-46N generated by analysis application 34 in any of a variety of ways. Reporting application generates, for example, reports that characterize the effectiveness of cleaning activities at the cleaning site based on the dispenser data, the corporate data, the product usage data, and the cleanliness metrics.

For example, reporting application 34 may generate a variety of reports to provide users with both qualitative and quantitative data regarding the chemical products dispensed, the dispensers, comparisons of data to performance and/or cost targets and/or comparisons of data over time. Reporting application 34 may also generate reports 48 that allow users to benchmark multiple dispensers, sites, alignments or corporations over periods of time as specified by a user. The reports 48 may also be an assessment tool that is used to assess the effectiveness of the cleaning services, to determine whether the proper procedures are being followed, and to recommend improvements in the cleaning procedures. The analysis and reporting applications may also reside locally at each site server, and may be used locally at each site to generate site-specific reports concerning the amounts of chemical product used, whether targets were met, quantification of cleaning results, etc.

The analysis application 32 and reporting application 34 may reside locally to the server computer 30 or may be accessed remotely. Analysis and reporting applications of varying complexity may also be executed and/or stored at each cleaning site 22, or on any other type of computing device such as a portable computer, laptop, remote computer, tablet PC, PDA, cell phone, etc, or any other computing device on which it may be desirable to review and/or analyze the chemical product usage information, cleaning metrics, and/or view accompanying reports.

Reports 48 may be accessed by various authorized users 54 over a network 52. Network 52 may be the same as network 24 (in the case of the internet, for example) or may be some other a network. Users 54 may include facility managers, operators, service technicians, dispenser vendors, corporate managers, executives or other users to whom the information presented in reports 48 may be valuable in helping to plan, analyze, or run the business. Reports 48 may be viewed on a computer monitor or hard copies of the reports may be printed out on a printer. Reports 48 may also be viewed or printed locally at each site via a local server or other computer, laptop, desktop computer, etc. The type of reports generated may be programmed into reporting application 34, may be selectable by a user, or may be a combination of both.

Reports 48 may include, for example, corporate summary or historical reports, site summary or historical reports, dispenser summary or historical reports, chemical product dispensing summaries or historical reports, benchmarking of multiple sites or dispensers, etc. Summary and historical reports may be available on a site-by-site basis, allowing the user a means of tracking dispensing of chemical products, errors and cost issues for an individual site. However, some cleaning problems may not be apparent on a site-by-site basis, and may only reveal themselves when analyzed across multiple sites. Therefore, a corporate summary, spanning multiple sites corresponding to a single alignment (where alignments are based on groupings of dispensers or sites that may be relevant to a particular corporation, such as all hotel sites within a corporation that also includes restaurant and retail sites), all liquid cleaner dispensers, all sites using a particular chemical product, etc.) or corporation, may be useful in identifying trends and corporate-wide cleaning problems. Accordingly, a business entity can effectively manage its cleaning operations on an individual dispenser basis, an individual site basis, a multiple site basis and/or a corporate-wide basis to manage cleaning costs and improve cleaning efficiency. Such information, for example, may be useful in developing training programs for cleaning employees, negotiating agreements, increasing cleaning efficiency and effectiveness, reducing costs and/or coordinating scheduled maintenance throughout a corporation's multiple sites. As mentioned above, analysis and reporting applications 32, 34 of varying complexity may also reside locally at each site 22 for local analysis and reporting.

Server computer 30 may receive data or otherwise communicate with sites 22A-22N on a periodic basis, in real-time, upon request of server computer 30, or at any other appropriate time. Server computer 30 may also send commands, instructions, software updates or other communications to sites 22A-22N via network 24. These communications may relate to an individual site, multiple sites, or to one or more dispensers at the sites. The communications between server computer 30 and sites 22A-22N may provide a feedback loop to the sites or to dispensers at the sites. The communications may include formula updates, calibration commands, test commands, alarm commands, interactive communications between a site manager or service technician and the dispenser vendor or server computer facility, and other remote control commands. This capability facilitates the management of multiple, geographically dispersed sites by allowing facility managers, operators, service technicians, dispenser vendors or other users to distribute control commands from a central location via the communications network 24. An example of the use of the feedback loop involves updating a formula stored in the storage medium of a dispenser based on analysis of dispenser data by the server computer 30.

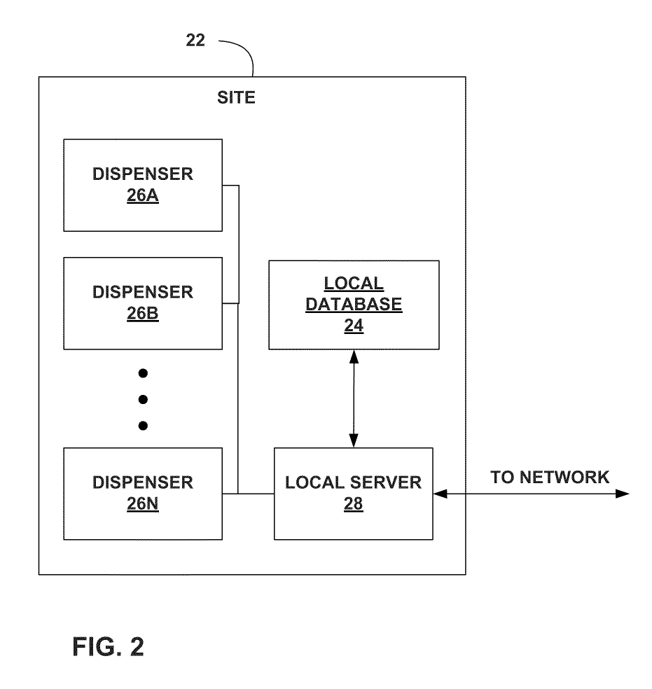

FIG. 2 is a block diagram illustrating an example chemical dispensing site 22. Each site 22 includes one or more chemical product dispensers 26A-26N (hereinafter referred to generally as dispensers 26). In this example, each site 22 also includes a local server computer 28 that communicates with the server computer 30 via network 24. However, it shall be understood that some or all analysis and reporting functions could be carried out locally at the site or at each dispenser, if desired, in addition to or instead of at server 30 (shown in FIG. 1).

Dispenser data collected by dispensers 26A-26N may be stored in a local database 24. In addition or alternatively, the collected data may be sent in real-time or at periodic intervals from dispensers 26 or local server computer 28 to server computer 30 to be stored in database 40. Although FIG. 2 shows a generalized server/database arrangement, it shall be understood that other arrangements may also be used and that the invention is not limited in this respect.

In one example, local database 24 may store all of the data types described above with respect to database 40 associated with that particular site 22. For example, local database 24 may store dispenser data 42 and corporate data 44 associated with the site. Local server computer 28 (or other local computer) may also include local analysis and reporting applications such as those described above with respect to analysis and reporting applications 32 and 34. In that case, local dispenser and corporate data may be analyzed and reports associated with the site may be generated and viewed locally, if desired. In other examples, all analysis and reporting functions may be carried out remotely at server computer 30, and reports may be viewed remotely over network 52, such as the internet. The reports, whether generated locally or remotely, may be viewed on a computer monitor and/or hard copies may be printed out on a printer. In other examples, some sites 22 may include local storage and/or analysis and reporting functions while other sites 22 rely on remote storage and/or analysis and reporting. Analysis and/or reporting functions may also be carried out by one or more dispensers at a site 22. Thus, although the general case of data being stored at the server database 40 and analysis/reporting being carried out by the server computer 30 is described herein, it shall be understood that these storage, analysis and reporting functions may also be carried out locally or at some other location, and that the invention is not limited in this respect.

The cleaning process management system may analyze the discrete types of dispenser data 42A-42N, corporate data 44A-44N and/or cleanliness metrics 50A-50N individually or selected dispenser data 42A-42N, cleanliness metrics 50A-50N and/or corporate data may be combined and analyzed to generate a variety of reports that characterize effectiveness of cleaning services at a single site, across multiple sites, or across a corporation. The sites may be grouped (or “aligned”) according to type of site, location, region, corporation, etc. Customized groups may also be created by a user and analysis and reporting operations carried on those customized groups, if so desired.

Reports 48 may also include information concerning calibration of dispensers, dispenser maintenance records, site calibration and maintenance, etc.

Reports 48 may also include cleaning process management reports that indicate means by which cleaning efficiency and/or effectiveness may be improved. For example, if the analysis application 32 indicates that certain target parameters (such as chemical product usage targets or cleanliness targets) were not satisfied, a process control report may include corrective actions that maybe taken to help ensure that target parameters are met. Process control reports may include, for example, chemical product recommendations (e.g., recommendations for specific chemical product(s)), recommended target amounts of chemical product(s) to be used, modifications to defined cleaning practices, equipment (e.g., cleaning tool) recommendations, equipment troubleshooting, retraining of personnel in proper cleaning/sanitizing procedures, dispenser maintenance recommendations, etc. Remediation plans may also be recommended to correct problems caused by the failure to meet target product usage parameters or cleanliness metrics. For example, extended failure to meet bathroom cleaner targets may lead to presence of mold or mildew, which may require additional products (e.g., mold/mildew remover), tools (e.g., special scrubbing or scraping tools) or maintenance (e.g., removal of tile or grout) to correct. As another example, cleanliness metrics below the target may indicate a need to change cleaning practices or procedures, retrain cleaning staff, etc.

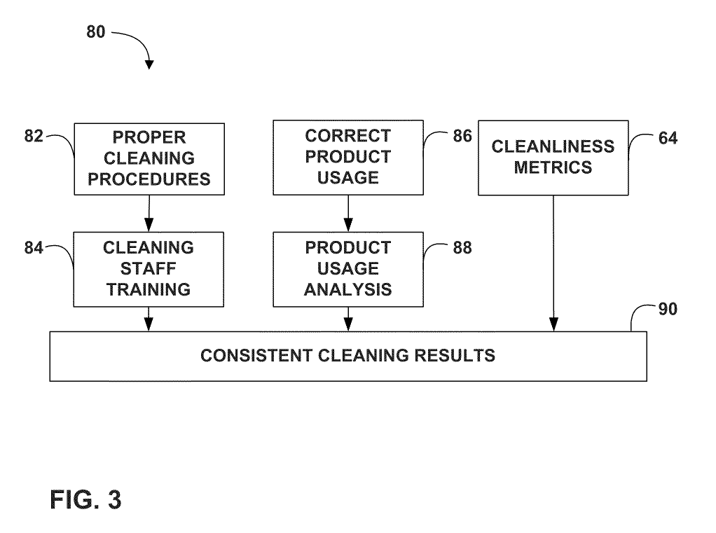

FIG. 3 is a block diagram illustrating example cleaning process management flow map 80. The cleaning process management system/method is a process oriented approach that seeks to monitor cleaning procedures and outcomes based on chemical product usage. Proper cleaning procedures (82) are defined and reinforced via cleaning staff training (84). Correct product usage (86) is monitored via product usage analysis (88). Training of cleaning staff (84) may be provided to the relevant cleaning staff to help ensure that defined best cleaning practices are followed. The cleaning process management system takes into account quantifiable cleanliness metrics (64) linked to process performance. The cleanliness metrics may include, for example, cleanliness scores obtained from guests or other users of the site. For example, if the site is a hotel, cleanliness metrics may be obtained from hotel guests via comment cards, online surveys, online forum reviews, verbal communications, etc. The cleanliness metrics may also include cleanliness scores from brand (corporate) audits or management audits of cleaning effectiveness. The cleanliness metrics may also include results of pathogen swab tests or other tests that measure cleaning/disinfecting effectiveness.

Depending upon the results of the analysis, cleaning process adjustment may be required. Cleaning process adjustment may include cleaning staff training (84), creation of proper cleaning procedures (82) (including product and/or tool recommendations) and/or recommendations of intermittent specialty products to remediate problems that may have arisen due to failure to follow cleaning processes or meet chemical product usage targets.

The result of the cleaning process management may lead to more consistent cleaning results. The improved results may include improved cleaning outcomes, including increases in cleaning efficiency and effectiveness, cost control, consistent delivery of an expected standard of cleanliness, increase in guest satisfaction, enhanced employee productivity, increased employee satisfaction and safety, etc. (90).

In general, the cleaning process management techniques described herein are based on the idea that chemical product usage is a leading indicator of future cleanliness metrics. For example, if chemical product usage falls below target levels, cleanliness metrics may show a corresponding decline. The decline in cleanliness metric(s) may lag the decline in chemical product usage by as little as a few days, to one month to as many as six months, depending upon the site. In order to maintain cleanliness metrics at a satisfactory level, the cleaning process management system monitors and analyzes chemical product usage and cleanliness metrics to maintain cleanliness metrics at a satisfactory level, and/or may recommend updated cleaning procedures, remediation measures, or cleaning staff training to return the cleanliness metrics to a satisfactory level if necessary.

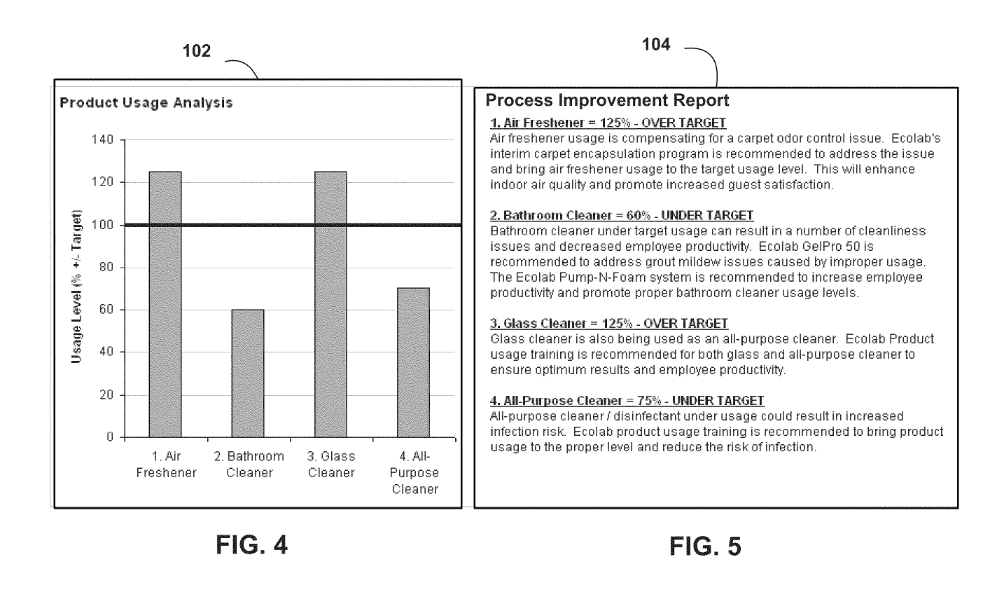

FIGS. 4-13 show example reports that may be generated by reporting application 34. These reports may include, for example, detailed analysis and reporting on key metrics, including actual product usage levels, target usage levels, cleanliness metrics, percent over/under target, analysis concerning the effective result of under or over usage, cleaning outcomes, behavioral observations, cleaning efficiency, products/tools overview, dispenser analysis, staff knowledge, employee satisfaction, patient satisfaction, etc. The reports may benchmark current site practices across the entire database or across other sites or other entities. The reports may include trending of various key metrics over time, provide actionable improvement plans and assess current practices relative to best practices. It shall be understood that the reports shown in FIGS. 4-8 are exemplary only, and that other reports may also be generated for each dispenser, site or business entity, and that other reports may also be generated for other dispensers, sites, or business entities, each including reports on data relevant to thereto, and the invention is not limited in this respect.

FIG. 4, for example, shows an example product usage report 102. Product usage report 102 shows product usage levels as a percent of target for four cleaning products: air freshener, bathroom cleaner, glass cleaner and all-purpose cleaner. Product usage report 102 also shows the percent over or under the target usage level for each of these products. Product usage reports such as product usage report 102 may be generated on an individual dispenser, site-wide, alignment-wide or corporate wide basis. It shall be understood that FIG. 4 shows one type of example product usage report, and that product usage reports may include other data and/or results generated by analysis application 32 or reporting application 34, that product usage reports may also take other graphical or text formats, and that the invention is not limited in this respect.

FIG. 5, for example, shows an example cleaning process management report 104. Process control report 104 shows recommended process improvements which may help to address the product usage inaccuracies shown in product usage report 102. For example, process control report 104 states the percent over/under target for each of the relevant chemical products, states whether they were under or over target, gives a short summary of the importance or purpose of each chemical product, recommends new products, tools and/or cleaning processes to address identified inaccuracies in product usage, and lists advantages that the recommended process improvement may provide. It shall be understood that FIG. 5 shows one type of cleaning process management report, and that other cleaning process management reports may also be generated that include other data and/or results generated by analysis application 32 or reporting application 34, that these reports may also take other graphical or text formats, and that the invention is not limited in this respect.

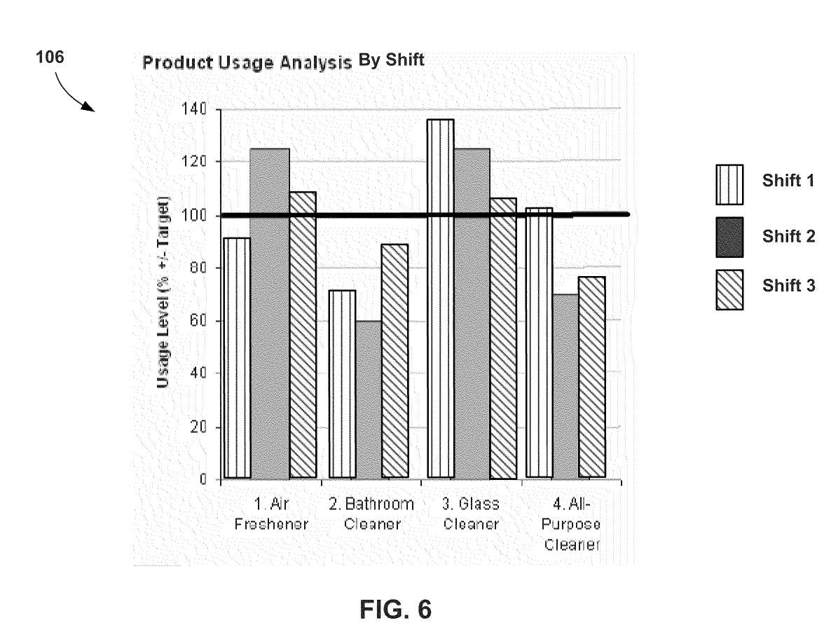

FIG. 6, for example, shows an example product usage by shift report 106. Product usage by shift report 106 shows product usage levels by shift as a percent of target for four cleaning products: air freshener, bathroom cleaner, glass cleaner and all-purpose cleaner. Product usage by shift report 106 also shows the percent over or under the target usage level that each shift was for each of these products. For example, report 106 illustrates that shift 1 failed to meet corporate targets for air freshener usage, while shifts 2 and 3 both exceeded corporate targets for air freshener usage. Report 106 also illustrates that all three shifts failed to meet corporate targets for bathroom cleaner usage, that all three shifts exceeded corporate targets for glass cleaner usage, and that shift 1 was very close to target product usage for all-purpose cleaner and that both shifts 2 and 3 failed to meet the target product usage for this chemical product. Product usage reports such as product usage report 106 may be generated on an individual dispenser, site-wide, alignment-wide or corporate wide basis. Reports such as product usage by shift report 106 may alert users to discrepancies in product usage between shifts, and may provide information concerning which cleaning shifts may require training as well as the type of training or process improvements that should be recommended for each shift.

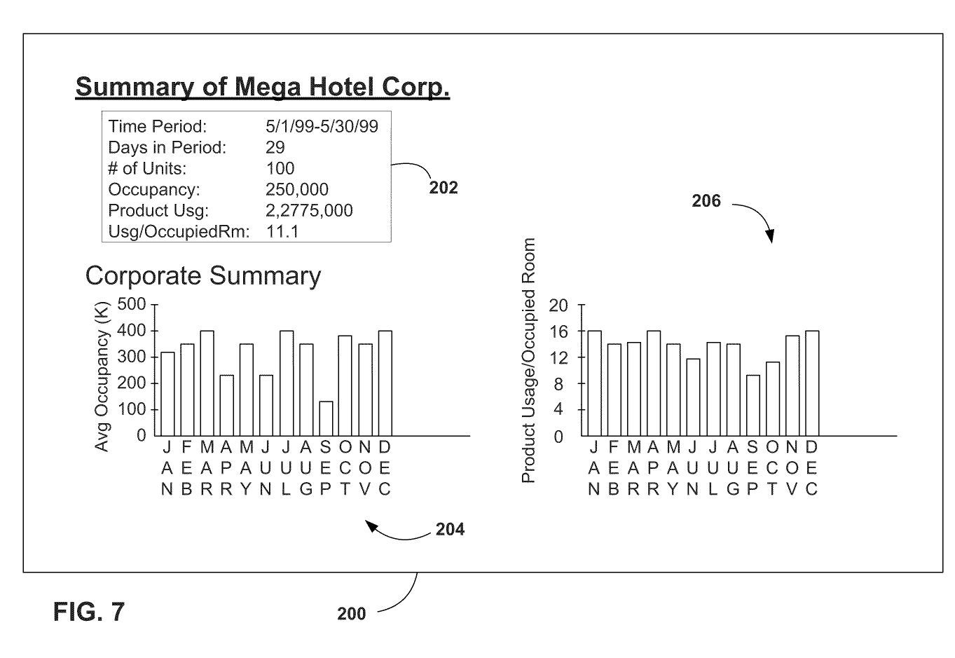

FIG. 7, for example, illustrates an exemplary corporate summary report 200 for a fictional corporation in an example of the present invention. Reporting application 34 generates corporate summary report 200 based on the relevant dispenser data, corporate data and/or product usage data stored in database 40. The report 200 relates to a summary of cleaning sites for a fictional hotel corporation. The hotel corporation in this example owns or manages multiple hotel sites.

The exemplary report 200 shows summary data for all sites of the fictional hotel corporation relating to a time period from May 1, 1999 to May 30, 1999, as shown in report section 202. The number of days in the time period is also shown. The number of units (“# of Units”) field shows the number of accounts included in the summary report, as grouped according to the corporate identification information. The “occupancy” label shows the number of occupied rooms within all of the corporation's sites (e.g., individual hotel facilities) included in the summary. The “Product Usage” label shows the amount of chemical product used during the time period. The “Product Usage/Occupied Rm” label shows a calculation based on the “Occupancy” and “Product Usage” fields. The Product Usage/Occupied Rm result is an example of product usage data derived from a combination of dispenser data and corporate data. The number of occupied rooms corresponding to a particular hotel site is corporate data used to manage the business operations within a corporation. This and other corporate data may be communicated to the database 40, for example, via a communications link from a business server computer.

The bar graph 204 shows the average occupancy (in units of 1,000 occupied rooms) on a monthly basis over a one year period. The bar graph 204 data is generated from real-time or historical occupancy data, which is an example of corporate data, received from the corporation and entered manually or automatically into the database. Bar graph 206 illustrates the chemical product usage per occupied room on a monthly basis over a one year period. The data reflected in bar graph 206 is also derived from dispenser data and corporate data recorded in the database.

A user viewing corporate summary report 200 conveys overall corporate product usage, allowing a user to evaluate trends, monthly shifts in product usage, and to track product usage with occupancy. Any discrepancies revealed by the data may be noted and more detailed reports may be generated and viewed to determine the reason for the discrepancies and to receive recommendations on how the cleaning processes may be improved to alleviate them.

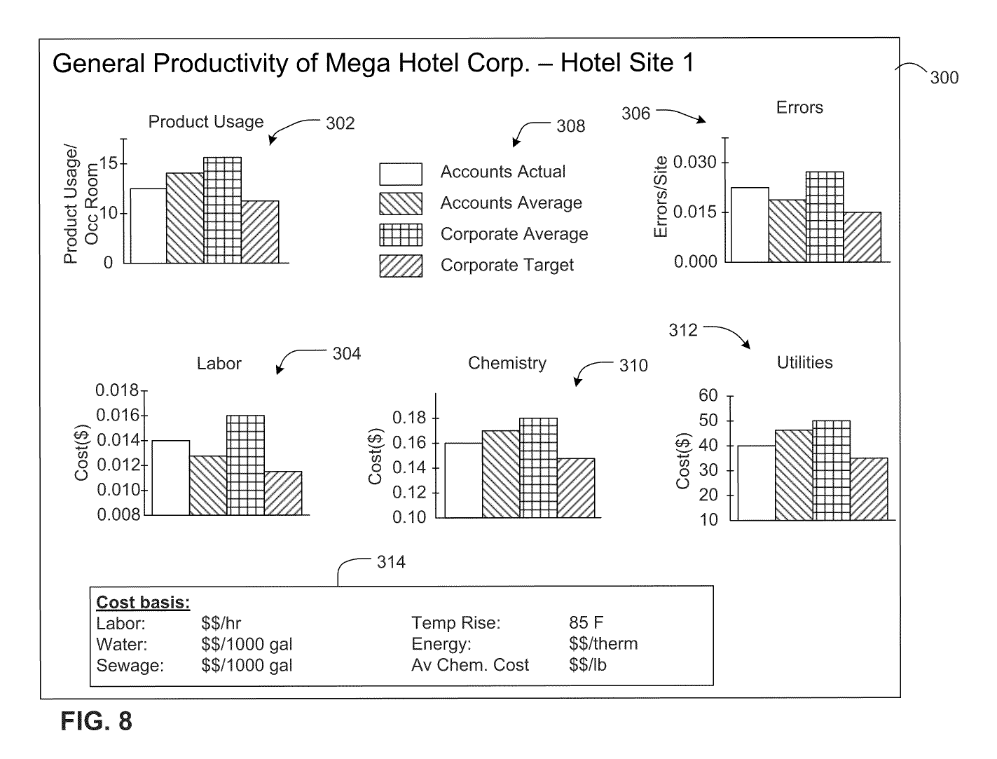

FIG. 8 illustrates an example general productivity and cost basis reports for an individual hotel site of a fictional hotel corporation. The report 300 includes bar graphs 302, 304, 306, 310 and 312. The bar graph 302 illustrates the total chemical product usage per occupied room. The bar graph 304 shows the cost of labor per occupied room associated with the cleaning operation. The bar graph 306 illustrates the number of procedural errors (e.g., the number of times the actual product usage failed to meet the target product usage) per occupied room. The bar graph 310 illustrates the cost of chemistry per occupied room. The bar graph 312 illustrates the cost of utilities per occupied room. As indicated by legend 308, the bar graphs 302, 304, 306, 310 and 312 include actual results concerning amounts of all chemical products dispensed, an average amount of all chemical products dispensed, the overall corporate average of all chemical products dispensed, and the corporate target for all chemical products dispensed.

The report section 314 summarizes the cost basis used in the report 300. The components of the report section 314 illustrate examples of corporate data recorded in database 40. The labor cost basis, for example, may be an average labor cost, or may be further broken out into specific labor costs for cleaning employees or for individual shifts. Likewise, the water, sewage and energy costs may be averages or estimates, or they may be updated on a real time basis. The temperature rise data element indicates the differential between the water temperature received from a public utility and the hot water temperature detected in a dispenser. The average chemical cost indicates the average chemical cost for all chemical products dispensed at the site.

Reports such as those shown in FIG. 8 may also be generated for individual chemical products, showing the product usage of each chemical product and the associated costs. Such reports may also include actual results for amounts dispensed of a particular chemical product, an average dispensed amount for the particular chemical product, the overall corporate average for the particular chemical product, and the corporate target for the particular chemical product.

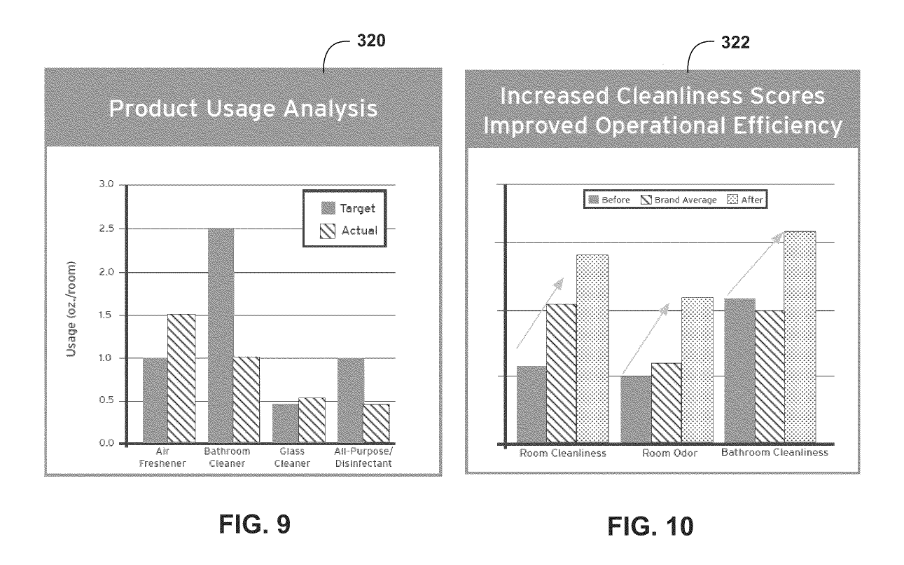

FIG. 9, for example, shows another example of a product usage report 320. Product usage report 320 shows actual product usage (ounces per room) and target product usage (ounces per room) for four cleaning products: air freshener, bathroom cleaner, glass cleaner and all-purpose cleaner/disinfectant. Product usage reports such as product usage report 320 may be generated on an individual site, group-wide, alignment-wide or corporate wide basis. It shall be understood that FIG. 9 shows one type of example product usage report, and that product usage reports may include other data and/or results generated by analysis application 32 or reporting application 34, that product usage reports may also take other graphical or text formats, and that the invention is not limited in this respect.

FIG. 10, for example, shows an example cleanliness metric report 322. Cleanliness metric report 322 shows relative cleanliness metrics for room cleanliness, room odor, and bathroom cleanliness before implementation of the cleaning process management protocol, the brand average and after implementation of the cleaning process management protocol. Report 322 indicates increased cleanliness scores in all three areas of measurement after implementation of the cleaning control protocol.

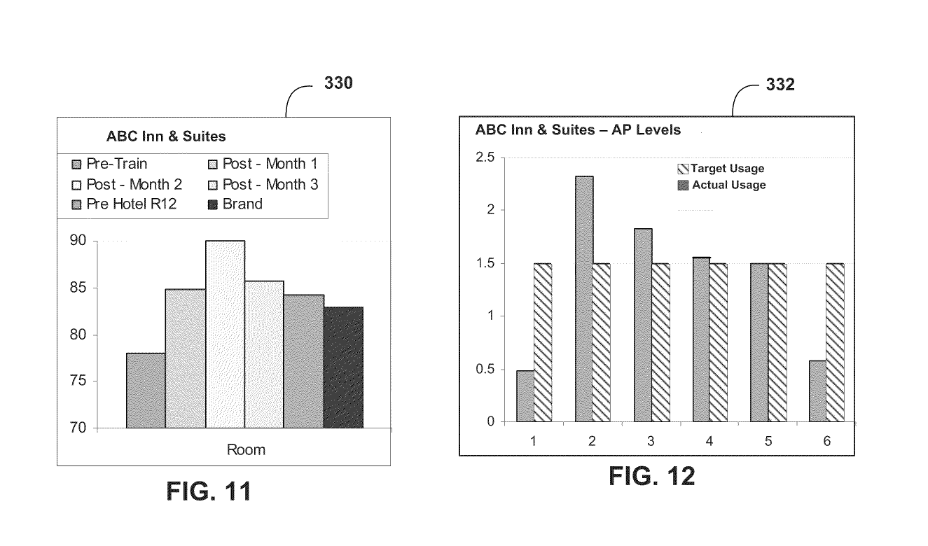

FIG. 11 shows another example cleanliness metric report 330 for a fictional hotel site, ABC Inn & Suites. Report 330 shows the average cleanliness metric per room for the pre-train, post train—month 1, post train—month 2, and post train—month 3 periods, as well as the pre hotel R12 and the brand average cleanliness metric. Report 330 may be generated on a per site basis, a group basis, a region basis, a corporate basis, etc.

FIG. 12 shows another example chemical product usage report 332 for a fictional hotel site, ABC Inn & Suites. Report 332 shows actual and target chemical product usage over time (e.g., on a monthly basis) for this site. At time T1, actual chemical product usage is significantly below target chemical product usage. Between time T1 and T2, updated cleaning procedures and training to these procedures is performed. At time T2, actual chemical product usage exceeds the target. This is a common result seen immediately after training as cleaning staff attempts to implement the new cleaning regimen. At time T3, T4 and T5, actual chemical product usage is very close to the target. At time T6, however, actual chemical product usage has declined below the target once more. This is also rather common as cleaning staff tends to fall back into their old ways of cleaning. In addition, turnover in cleaning personnel may be relatively high, resulting in a mismatch between actual and target chemical product usage if training is not administered on a regular basis.

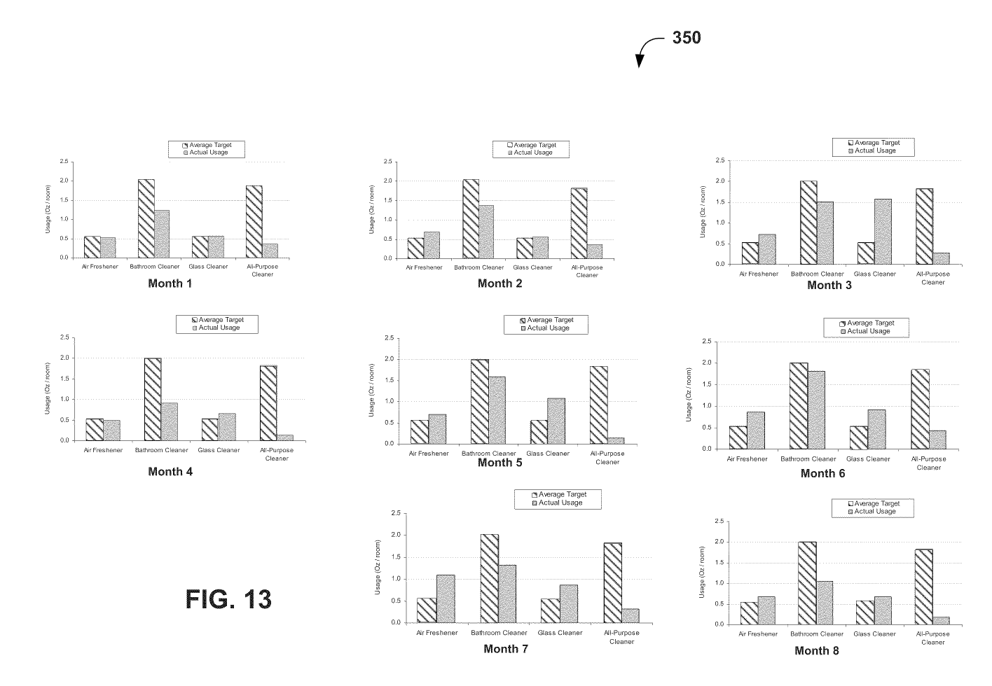

FIG. 13 shows a month by month chemical product usage report 350. Report 350 shows actual product usage (ounces per room) and target product usage (ounces per room) for four cleaning products: air freshener, bathroom cleaner, glass cleaner and all-purpose cleaner/disinfectant over the course of 8 months. Such a report may be generated for a single site, a group of sites, a corporation, etc.

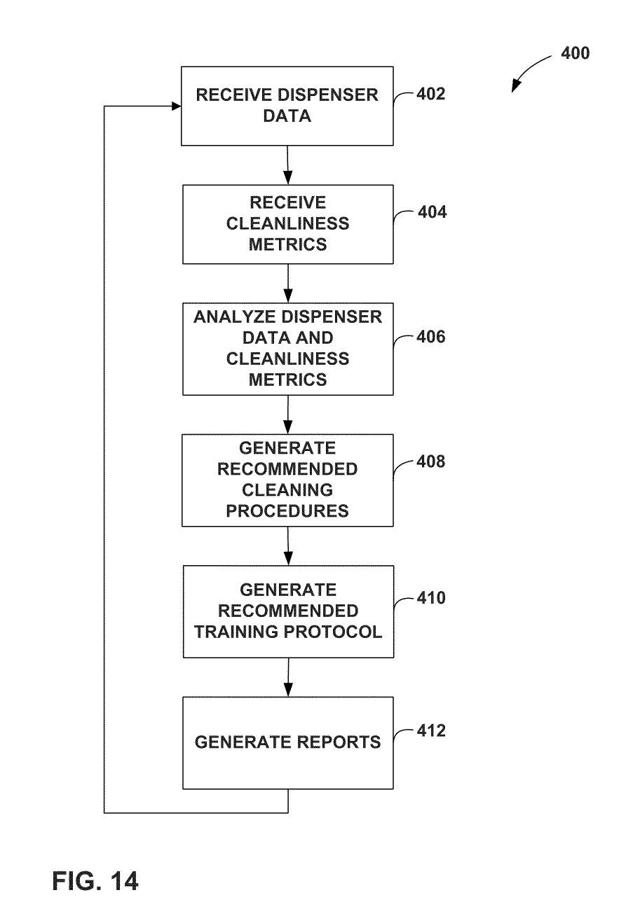

FIG. 14 is a flowchart illustrating an example process (400) by which the cleaning process management system may analyze chemical product usage and cleanliness metrics. A processing apparatus (processor), such as one or more processor(s) that form part of server computer 30, local server 28, or other processing device (such as a portable computer, laptop, remote computer, tablet PC, PDA, cell phone, or any other computing device on which it may be desirable to review and/or analyze the chemical product usage information, cleaning metrics, and/or view accompanying reports) receives the dispenser data obtained by one or more dispensers 22 (such as dispensers 22A-22N of FIG. 2) (402). The dispenser data may be retrieved from a memory or may be received directly from the relevant dispensers. The processor also receives cleanliness metrics (404). The dispenser data and the cleanliness metrics received would be those pertaining to the site or sites for which the cleaning processes currently subject to analysis. Dispenser data and cleanliness metrics may also be received from other predetermined or selected sites for purpose of comparison.

The processor analyzes the dispenser data and the cleanliness metrics (406). The dispenser data may be analyzed independently and/or in conjunction with corporate data to generate product usage data. The dispenser data, the corporate data, the product usage data and/or the cleanliness metrics may also be analyzed independently and/or in various combinations with each other to determine, among other things, whether target parameters for product usage and/or cleanliness metrics are being met.

Based on this analysis, the processor may generate recommended cleaning procedures (408) and/or a recommended training protocol (410). For example, if the targets for product usage and/or cleanliness metrics are being met, processor may recommend that established cleaning procedures and targets continue to be followed. As another example, if the targets for either or both of product usage and/or cleanliness metrics are not being met, the processor may obtain a different recommended cleaning/training procedure based on this failure to meet the target(s).

The processor may then generate reports (412). The reports may include any of those described and/or shown above, and may also include other reports not specifically shown or described herein but that would be useful in the management of a cleaning process. The reports may include, for example, actual amounts of chemical products dispensed, actual cleanliness metrics received, comparisons between actual and target amounts of chemical product dispensed, comparisons between actual and target cleanliness metrics, reports concerning recommending cleaning and/or training procedures, etc.

The process (400) may be carried out periodically (e.g., such as weekly, monthly, quarterly, or other time frame relevant to the site, company, or application) so as to monitor and/or manage cleaning processes at one or more sites on an on-going basis.

As described herein, some parts of the cleaning process management system may be computer implemented, and as such may be incorporated into computer software or hardware. For example, a computer system may collect and analyze data generated during implementation of the cleaning process management system. A computer implemented system may analyze data to determine whether usage of particular products meets specified targets, and may perform statistical analysis on a dispenser, site or entity-wide basis. The product usage data may be analyzed in conjunction with any type of corporate data, such as product cost information, utility costs, employee identification or cost information. This information may be stored and analyzed and reports generated to provide feedback to a facility manager or corporation. Furthermore, the analysis may be performed across multiple accounts, such as multiple accounts within a single corporation or organizational region, to compare, for example, one or more dispensers, sites or regions in a corporation with other dispensers, sites or regions within the same corporation.

The techniques described herein may be implemented in hardware, software, firmware or any combination thereof. If implemented in software, the techniques may be realized at least in part by a computer-readable medium comprising instructions that, when executed by computer of a validated healthcare processing system cause the computer to perform one or more of the techniques of this disclosure. The computer-readable data storage medium may form part of a computer program product, which may include packaging materials. The computer-readable medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, a magnetic disk or a magnetic tape, a optical disk or magneto-optic disk, CD, CD-ROM, DVD, a holographic medium, or the like. The instructions may be implemented as one or more software modules, which may be executed by themselves or in combination with other software.

The computer-readable instructions may be executed in the computer of the system by one or more processors, general purpose microprocessors, ASICs, FPGAs or other equivalent integrated or discrete logic circuitry.

The instructions and the media are not necessarily associated with any particular computer or other apparatus, but may be carried out by various general-purpose or specialized machines. The instructions may be distributed among two or more media and may be executed by two or more machines. The machines may be coupled to one another directly, or may be coupled through a network, such as a local access network (LAN), or a global network such as the Internet. Accordingly, the term “processor,” as used herein may refer to any structure suitable for implementation of the techniques described herein.

The invention may also be embodied as one or more devices that include logic circuitry to carry out the functions or methods as described herein. The logic circuitry may include a processor that may be programmable for a general purpose or may be dedicated, such as microcontroller, a microprocessor, a Digital Signal Processor (DSP), an Application Specific Integrated Circuit (ASIC), a field programmable gate array (FPGA), and the like.

One or more of the techniques described herein may be partially or wholly executed in software. For example, a computer-readable medium may store or otherwise comprise computer-readable instructions, i.e., program code that can be executed by a processor to carry out one of more of the techniques described above.

The process control method may also incorporate worker training and continuing education, such as teaching new or ongoing skills and changing paradigms and behaviors within the cleaning entity. These may include, for example, on-site cleaning process training/validation/usage, compliance/procedural training, training oversight/monitoring/interventions, comprehensive training to impact outcomes, certification training, etc. The training may include both upfront and periodic refresher training, training materials and a training process created for each site or entity to assure that housekeepers are following best practices defined for that site/entity and using the proper tools and products to assure the use of the process control system will increase the quantified cleanliness of a particular site.

The cleaning process management system and method described herein thus provides a comprehensive system that quantifies cleaning results by, for example, the amount(s) of chemical product(s) dispensed, and may provide recommendations for targeted training and/or cleaning process improvements. Advantages may include higher compliance rates with best cleaning practices. The cleaning process management system may also provide cost reductions through improved operational efficiencies and a reduction in worker errors and inconsistencies. The end result may include improved cleaning outcomes, including increases in cleaning efficiency and effectiveness, consistent delivery of an expected standard of cleanliness, increased guest satisfaction, enhanced employee productivity, increased employee satisfaction and safety, etc.

Although the cleaning process management systems and methods have been described with respect to cleaning services, it shall be understood that this concept may also be applied to the cleaning and sanitation best practices in many different enterprises in which monitoring and reporting of information related to chemical product dispensing may be beneficial. For example, the system may be adapted for use in applications such as hotel room cleaning, education facilities, long term care, restaurants, food service, food and beverage facilities, eating areas, rest rooms, food preparation areas, cooking areas, and any other facility in which where cleaning services are required.

The cleaning process management system and method can be used by any entity that can quantify cleaning or sanitizing results by the amount or volume of product used. For example, in an institutional or restaurant environment, monitoring the product usage of cleaning products such as floor cleaner, bleaches, disinfectant cleaners, glass cleaners, oven cleaners, tile and sink cleaners, etc. may be used to improve cleaning processes and ensure proper procedures are being used.

In a healthcare environment, the process control system may monitor product usage levels that can be used to provide proof of delivery of disinfecting products, sanitizing products, instrument care detergents, etc. Administrators can use this information to provide insight as to ways to improve their instrument care process (e.g., problem with dispenser, problem with instrument washer, etc.).

The process control system may also monitor hand hygiene levels based on the amount or volume of hand sanitizing or detergent product used. Usage levels can be compared to known levels and a hand hygiene compliance rate can be calculated.

In a vehicle care environment, the process control system may monitor information concerning product usage levels of multiple vehicle care products, along with water consumption data, which may be compared to ideal levels of usage. The carwash process may then be optimized based on target levels, saving the customer cost in product, water and labor.

In a textile care/laundry environment, the process control system may monitor solid and/or liquid laundry product usage levels and the information can be used to improve the laundry process. For example, if a hotel of a known room size and occupancy rate is not getting good results, the laundry product usage levels may be monitored to identify which products are being over or under used. With that information a technical service provider can coach the account on proper laundry processes.

Various embodiments of the invention have been described. These and other embodiments are within the scope of the following claims.

1. A system comprising:
a server computer that receives dispenser data from a chemical product dispenser located at a cleaning site, the dispenser data including an amount of a chemical product dispensed by the chemical product dispenser;
a database coupled to the server computer that stores the dispenser data in association with corporate data regarding the cleaning site and that stores cleanliness metrics associated with the dispensing site; wherein the corporate data includes cleaning site identification information, corporate target amounts of chemical product to be dispensed, and at least one target cleanliness metric;
an analysis application resident on the server computer that analyzes the dispenser data in combination with at least some of the corporate data and generates therefrom product usage data indicative of the actual amount of chemical product usage at the cleaning site, and analyzes the cleanliness metrics in combination with the target cleanliness metrics; and
a reporting application resident on the server computer that generates reports based on the analysis.

2. The system of claim 1, wherein the server computer is located remotely from the cleaning site.

3. The system of claim 1, wherein the server computer is local to the cleaning site.

4. The system of claim 1, wherein the reporting application generates reports comparing current product usage data with historical product usage data.

5. The system of claim 1, wherein the dispenser dispenses a plurality of chemical products and the corporate data includes target parameters for each of the plurality of chemical products.

6. The system of claim 1, wherein the reporting application generates reports that indicate whether the target parameters for each of the plurality of chemical products were satisfied.

7. The system of claim 1, wherein the reporting application generates reports that indicate whether the at least one target cleanliness metric for the cleaning site was satisfied.

8. The system of claim 1, wherein the reporting application generates reports that characterize the effectiveness of cleaning activities at the cleaning site based on the dispenser data, the corporate data, the product usage data, and the cleanliness metrics.

9. A system comprising:
a memory that stores dispenser data obtained by one or more chemical product dispensers located at a cleaning site, the dispenser data including actual amounts of chemical products dispensed by the one or more chemical product dispensers, wherein the memory further stores corporate data including cleaning site identification information, corporate target amounts of chemical products to be dispensed, and at least one target cleanliness metric, wherein the memory further stores cleanliness metrics associated with the dispensing site; and
a processing apparatus that analyzes the dispenser data the cleanliness metrics and generates reports based on the analysis.

10. The system of claim 9 wherein the processing apparatus further compares the actual amounts of chemical products dispensed with target amounts of chemical products and generates reports based on the comparison.

11. The system of claim 9 wherein the processing apparatus further compares the cleanliness metrics with the at least one target cleanliness metric and generates reports based on the comparison.

12. The system of claim 9 wherein the processing apparatus generates reports that characterize the effectiveness of cleaning activities at the cleaning site based on the dispenser data, the corporate data, and the cleanliness metrics.

13. The system of claim 9, wherein the processing apparatus generates reports comparing current product usage data with historical product usage data.

14. A system comprising:
one or more cleaning sites, each cleaning site including one or more chemical product dispensers that dispense at least one chemical product and generate dispenser data indicative of actual amounts of chemical product dispensed; and
a server computer in communication with each of the cleaning sites, the server computer including:
an analysis application that analyzes the dispenser data and the cleanliness metrics associated with each cleaning site; and
a reporting application that generates reports based on the analysis.

15. The system of claim 14 wherein the server computer further compares the actual amounts of chemical products dispensed with target amounts of chemical products and generates reports based on the comparison.

16. The system of claim 14 wherein the server computer further compares the cleanliness metrics with the at least one target cleanliness metric and generates reports based on the comparison.

17. The system of claim 14 wherein the server computer generates reports that characterize the effectiveness of cleaning activities at the cleaning site based on the dispenser data and the cleanliness metrics.

18. The system of claim 4, wherein the server computer generates reports comparing current product usage data with historical product usage data.
